(19) United States
(12) Patent Application Publication
(10) Pub. No.: US 2021/0359516 A1
(43) Pub. Date: Nov. 18, 2021

(54) METHOD AND SYSTEM FOR ENERGY MANAGEMENT

(71) Applicant: ZEN ECOSYSTEMS IP PTY LTD, Box Hill, Victoria (AU)

(72) Inventors: Grant Ian L. HATAMOSA, Bayswater North, Victoria (AU); James MURACA, Hoppers Crossing, Victoria (AU); David JONES, Mentone, Victoria (AU); David HEMMI, Elwood, Victoria (AU)

(21) Appl. No.: 17/278,447

(22) PCT Filed: Sep. 26, 2019
(86) PCT No.: PCT/AU2019/000121

§ 371 Date: Mar. 22, 2021

(30) Foreign Application Priority Data
Sep. 26, 2018 (AU) 2018903635

(51) Int. Cl. H02J 3/14; G06Q 10/06; G06Q 50/06; G06Q 30/02; G05B 13/04; H02J 3/32; H02J 3/00; F24F 11/46

(52) U.S. Cl. CPC H02J 3/144; G06Q 10/06312; G06Q 10/06313; G06Q 50/06; G06Q 30/0202; G06Q 30/0201; H02J 2310/64; G05B 13/048; H02J 3/32; H02J 3/003; F24F 11/46; H02J 2310/14; G06Q 10/06375

(57) ABSTRACT

The present application relates to the control and management of an energy system in coordination with a fluctuating energy market and, in one form provides a method for managing supply of energy to a number of energy consuming devices connected to a power distribution system of an energy supply system. The method may include the steps of: (1) monitoring one or more parameters affecting energy usage, (2) acquiring a first set of values based on the parameters, (3) calculating a set of predicted future values based on the first set of values, (4) identifying a context related to the first set of values, and (5) presenting control actions to increase efficiency of energy supply in response to the context.

### FIELD OF INVENTION

The present invention relates to the field of energy management. In particular, the present invention relates to the control and management of an energy system in coordination with a fluctuating energy market. While the present invention will be described with reference to the domestic energy market, the person skilled in the art will appreciate that both commercial and domestic energy customers might benefit depending on the pricing structure for their energy charges. It will be convenient to hereinafter describe the invention in relation to the use of battery storage and HVAC (Heating Ventilation and Air Conditioning) system components converting energy between chemical, thermal, kinetic and other energy forms, however it should be appreciated that the present invention is not solely limited to that use.

### BACKGROUND ART

It is to be appreciated that any discussion of documents, devices, acts or knowledge in this specification is included to explain the present invention. Further, the discussion throughout this specification comes about due to the realisation of the inventor and/or the identification of certain related art problems by the inventor. Moreover, any discussion of material such as documents, devices, acts or knowledge in this specification is included to explain the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Some example prior art systems for control of HVAC systems are as follows.

U.S. Pat. No. 7,343,226 (Ehlers et al) discloses a system and method to manage delivery of energy from a distribution network to one or more sites. Each site has at least one device coupled to the distribution network. The at least one device controllably consumes energy. The system includes a node and a control system. The node is coupled to the at least one device for sensing and controlling energy delivered to the device. A control system is coupled to the node and distribution network for delivery to the node at least one characteristic of the distribution network. The node controls the supply of energy to the device as a function of the at least one characteristic. However, this system primarily relates to a delivery mechanism in which control is either reactive in nature or without any information on how such control was created.

U.S. Pat. No. 8,843,238 (Wenzel et al) discloses systems and methods for limiting power consumption by a heating, ventilation, and air conditioning (HVAC) subsystem of a building. A feedback controller is used to generate a manipulated variable based on an energy use setpoint and a measured energy use. The manipulated variable may be used for adjusting the operation of an HVAC device. However, the feedback controller overrides user input during demand limiting events effectively restricting the user input, which leads to compromising or impinging upon user comfort.

US patent publication No. 2014/0067132 (Macek et al) discloses a thermal control system for a building, which includes a regression model: Given a forecast temperature outside the building, the regression model predicts how much an HVAC system will cost to run during a day, for a given set of time-varying target temperatures for all the thermostats in the thermal control system. The thermal control system may also include an optimizer, which invokes multiple applications of the regression model. Given a forecast temperature outside the building, the optimizer predicts an optimal set of time-varying target temperatures for all the thermostats in the thermal control system. Running the HVAC system with the optimal set of time-varying target temperatures should have a reduced or a minimized cost, or a reduced or minimized total energy usage. The optimizer works by running the regression model repeatedly, while adjusting the time-varying target temperature for each thermostat between runs of the model. Essentially the system of Macek et al relates to a method for adjusting a HVAC system's setpoint temperature based on a forecasted ambient temperature.

In the control and management of an energy system there are many attempts recorded in the prior art that have been made to try to balance user comfort against a number of competing inputs.

For example, US patent application publication No. 2013/0178985 (Lombard et al) relates to a HVAC controller that regulates HVAC operation based on a scheduling program that includes time of use pricing. A user adjustable new usage period may be created based upon a graphical overlay of the schedule and a pricing overlay. This method is typical of the prior art in so far as it is very simple in terms of the number of inputs and cannot effectively compare the multiple competing parameters that affect energy use and cannot adjust to their changes.

US patent publication No. 2010/0282857 (Steinberg) provides a system and method for reducing the usage of a ventilation system. An example system comprises a thermostatic controller that has at least two settings for the delay occurring between turning the ventilation system off and then turning the system back on. One setting being for a first interval and at least a second setting for a second interval that is longer than the first interval. A processor is in communication with the thermostatic controller and is configured to evaluate one or more parameters including at least the temperature outside the structure conditioned by the ventilation system. The processor is further configured to determine whether to adopt the first interval or the second interval based upon the values of the parameters. This system is an example of feedback determined exclusively in relation to the physical and thermodynamic properties or parameters of the HVAC system.

US patent publication No. 2012/0305661 (Malchiondo et al) provides a HVAC controller with predictive set-point control. The controller receives a set of internal temperature values, and a set of external temperature values, the set of external temperature values representing at least one non-current temperature. The controller determines a predictive internal temperature value from the set of internal temperature values and a predictive external temperature value from the set of external temperature values. The controller receives an internal humidity value representing humidity within the premise, the controller further controls the HVAC equipment to modify the humidity within the premise when the received internal humidity value is different from a humidity set point; and the humidity set point is regulated by a humidity limit value, the humidity limit value being where condensation forms, the humidity limit value being calculated using the predictive internal temperature value and the predictive external temperature value. This system is also an example of feedback determined exclusively in relation to the physical and thermodynamic properties or parameters of the HVAC system.

US patent publication no. 2013/0018513 (Metselaar) discloses a HVAC controller with predictive set-point control. Again, this system is also an example of feedback determined exclusively in relation to the physical and thermodynamic properties or parameters of the HVAC system. A controller is provided for operating HVAC equipment using an environmental control program. The controller has an environmental sensor operable to provide a measured temperature value to the environmental control program. The controller further runs a dynamic temperature control program that is operable to provide a dynamic correction factor to the environmental control program that dynamically compensates the measured temperature value for waste heat generated by power consumption within the controller.

U.S. Pat. No. 4,897,798 (Cler) relates to an adaptive HVAC environmental control system that adapts to the continually changing thermal characteristics of a building in which it operates. It repeatedly measures, then predicts future thermal characteristics of the building and the environment to calculate the performance of both the building and the HVAC system. Predictions are continually compared with measurements and adjusting the HVAC accordingly. As with the above prior art examples, this type of system does not take into account the cost of running the HVAC or make predictions based on the competing parameters of energy use and pricing regime.

US patent application 2010/0318227 (Steinberg et al) describes a system that determines the appropriate time at which a climate control system should turn on in a structure (such as a building) based on performance characteristics of the climate control system, thermal characteristics of the structure and variable inputs such as the temperatures inside and outside the structure. Other inputs used by the system include the user's energy bills, and information about the user's home. Predictions are created to determine the expected rate of change of temperature or other variables. However, since the system disclosed uses energy bills this only provides historical energy use and pricing. Furthermore, the disclosed system does not take any account of user behaviour in any historical sense or otherwise.

U.S. Pat. No. 5,924,486 (Ehlers et al) relates to an environment condition control and energy management system. Inputs include environmental conditions desired by the user for at least one energy unit price point based on which a schedule of projected energy unit prices per time period. Environmental condition deadband ranges are computed for multiple energy unit price points based on user input parameters and are used to control at least one energy consuming device to maintain the indoor conditions within the computed deadband range for a then-current energy unit price point. Again, the system disclosed has disadvantages in that it is limited to a consideration of only environmental conditions desired by the user.

U.S. Pat. No. 7,561,977 (Horst et al) relates to a system that facilitates and implements energy savings decisions by a home owner. A controller in logical communication with energy consuming appliances responds to requests for energy from the appliances by permitting or curtailing energy supply to the appliances based on evaluation of a plurality of logical considerations. The controller may be operated to provide energy to fewer than all the energy requesting appliances to reduce the energy demand on an energy supply source, including the instantaneous peak demand. However, this system is simply reactive to an energy demand request from the appliances and makes supply decisions between a current time and a future time. Furthermore, it is reliant on an actual change in energy use to occur for it to invoke any energy savings.

Electricity pricing structures are typically based on (a) time, such as a time of day, or season and, (b) aggregate demand, which gives rise to peak demand charges. For example, commercial customers are often billed on the basis of a combination of fixed customer charges, usage charges such as the number of kWh of energy consumed that may depend on the time of day, and overall demand. Time dependent pricing and demand charges are an incentive for customers to smoothen out the aggregated demand pattern over the whole day, which in turn helps the network operator.

Electricity is consumed by myriad tasks that increase comfort and safety of occupants. The electricity consumption required to complete a task depends on environmental circumstances. For example, cooling down a house requires less energy when the outside temperature is relatively low compared to when the outside temperature is high. Similarly, cooling down a meeting room to a desired temperature requires more energy if it is exposed to direct sunlight, compared to when it is in shade.

Electricity consuming tasks are often automatically carried out in the absence of a purpose. Many HVACs and lighting systems operate on a pre-set schedule. As a result, rooms may be lit up, heated or air conditioned even when empty. At least one prior art attempt to address this particular problem is disclosed in U.S. Pat. No. 8,180,492 (Steinberg) in which systems and methods are provided for detecting the use of networked consumer electronics devices as indications of occupancy of a structure for purposes of automatically adjusting the temperature setpoint on a thermostatic HVAC control. At least one thermostat is located inside a structure and is used to control an HVAC system in the structure. At least one networked electronic device is used to indicate the state of occupancy of the structure. The state of occupancy is used to alter the setpoint on the thermostatic HVAC control to reduce unneeded conditioning of unoccupied spaces.

One of the problems to be addressed is how to minimize the cost of electricity in terms of consumption and price without substantially compromising user comfort and safety.

U.S. Pat. No. 8,010,237 (Cheung et al) discloses systems and methods for ramping setpoints on thermostats controlling HVAC systems. A remote processor is in communication with a thermostat located inside a structure and a database stores data reported by the thermostat. A processor compares the outside temperature at a location and at least one point in time to information reported to the remote processor from the thermostat. The remote processor ramps the setpoint on the thermostat so as to reduce the average spread between inside temperature and outside temperature in order to reduce energy consumption without affecting comfort. The remote processor takes into account the effect of weather conditions and occupant preferences in determining whether and when to ramp setpoints.

U.S. Pat. No. 7,908,117 (Steinberg et al) discloses systems and methods for verifying the occurrence of a change in operational status for climate control systems in which a climate control system measures temperature at a first location conditioned by the climate control system. One or more processors also receive measurements of outside temperatures from at least one source other than the climate control system and compares the temperature measurements from the first location with expected temperature measurements. The expected temperature measurements are based at least in part upon past temperature measurements obtained by the climate control system and the outside temperature measurements. A server transmits changes in programming to the climate control system based at least in part on the comparison of the temperature measurements with the expected temperature measurements.

The preceding discussion of background art is intended to facilitate an understanding of the present invention only. The discussion is not an acknowledgement or admission that any of the material referred to is or was part of the common general knowledge as at the priority date of the application.

### SUMMARY OF INVENTION

It is an object of the embodiments described herein to overcome or alleviate at least one of the above noted drawbacks of prior art systems or to at least provide a useful alternative to prior art systems.

It is a further object of the present invention to minimize the cost of electricity without substantial compromise on user comfort or safety.

In a first aspect of embodiments described herein there is provided a method for managing supply of energy to a plurality of energy consuming devices connected to a power distribution system of an energy supplying system, the method comprising:
(1) monitoring one or more, preferably a plurality of parameters affecting energy usage,
(2) acquiring a first set of values based on the parameters,
(3) calculating a set of predicted future values based on the first set of values,
(4) identifying a context related to the first set of values, and
(5) presenting control actions to increase efficiency of energy supply in response to the context.

In one embodiment, at step (5) the control actions may be presented in a mode of automatic control of the operation of one or more energy consuming devices. Alternatively, the control actions may be presented to a user, preferably electronically via a mobile device, such as a mobile telephone. The user may then opt or select to implement or veto one or more of the control options presented. The user may be a customer of a commercial energy provider. The options chosen by the customer—whether to implement or veto—may be logged and in the future, be one of the energy usage parameters monitored in step (1).

The parameters monitored are typically chosen from one or a combination of an energy pricing structure; a schedule for an energy consuming appliance; weather or weather conditions; aggregate electricity consumption; historical electricity consumption; and historical user feedback.

The first set of values acquired from the parameters could include one or a combination of values such as energy demand peak times, prices, temperature, humidity and so forth.

The first set of values may then be used to predict future values such as predicted energy consumption patterns opposite predicted cost impacts.

The predicted future values are then used to identify a ‘context’. Where used herein, the term ‘context’ is intended to refer to an opportunity to increase efficiency, either in terms of saving money or reducing energy. For example, the context could relate to a predetermined condition relating to a schedule of an appliance (such as a HVAC) or a pricing structure of an energy supplier. After identifying the occurrence, or anticipated occurrence of a context, one or more appropriate control actions are presented to produce increased efficiency of energy supply, in terms of reducing energy consumption, or in financial terms by saving cost, or both. As mentioned above, the control action may be presented automatically, so that the relevant appliances implement them. Alternatively, they may be presented to a user who has an option to implement each control action or veto its implementation.

In another aspect of embodiments described herein there is provided a system for managing supply of energy to a plurality of energy consuming devices said system including a computer usable medium having computer readable program code and computer readable system code embodied on said medium for managing supply of energy usage across the plurality of energy consuming devices, said computer program product including computer readable code within said computer usable medium for:
(1) monitoring one or more, preferably a plurality of parameters relating to energy usage,
(2) acquiring a first set of values based on the parameters,
(3) calculating a set of predicted future values based on the first set of values,
(4) identifying a context based on the first set of values, and
(5) presenting control actions to increase efficiency of energy supply in response to the context.

In yet a further aspect of embodiments described herein there is provided an apparatus adapted to control energy usage across a plurality of energy consuming devices wherein each said apparatus comprising;
processor means adapted to operate in accordance with a predetermined instruction set, and
said apparatus, in conjunction with said instruction set, being adapted to perform the method of the present invention as herein described.

Other aspects and preferred forms are disclosed in the specification and/or defined in the appended claims, forming a part of the description of the invention.

In essence, embodiments of the present invention stem from the realization that the impact of HVAC and other electricity consuming appliances on electricity cost can be minimised by incorporating contextual awareness of electricity pricing structure, aggregate consumption and environmental contexts into a control scheme for energy supply.

Advantages provided by the present invention comprise one or a combination of the following:
provides reactive control of energy usage in response to a context occurring;
provides proactive control of energy usage in anticipation of a context occurring;
provides an estimate of the actual cost of electricity by detecting a context, and combines it with energy demand management;
provides a system that presents a user with options so that they can make decisions regarding electricity consumption;
by having the ability to make decisions a customer is better informed and understands the basis for control actions;
the customer can input information relating to intangibles such as personal preferences and the automatic system can refer to these inputs when calculating or presenting future proposed control actions;
creates efficiencies by managing energy demand and/or minimising electricity costs without compromising user comfort
The present invention is beneficial to battery storage because: (1) it reduces the number of discharge/charge cycles of a battery storage thus prolonging the lifetime of the battery; and, (2) it can minimise the capacity of battery storage needed by providing greater energy savings which in turn provides additional financial savings to the user;
The present invention utilises real-time energy use and energy pricing information while prior art systems only utilise energy bills that provide historical energy use and pricing;
The present invention utilises historical user behaviour such as cancelling a contextual override, or changing the amount of change that was applied by the contextual override. Based on this information the system of preferred embodiments will then adjust a future contextual override event;
A practical advantage of the present invention is the consideration of the “human in the loop” aspect of climate control adjustment as the description of how historical user behaviour is utilised in applying a contextual override;
Given that the present invention includes use of historical user behaviour and not just environmental conditions desired by the user, it has a practical advantage in that by considering historical user behaviour it can reduce the number of instances where the user vetoes the contextual override;
The present invention is predictive in nature rather than reactive, and accordingly, the present invention predicts energy consumption patterns, and cost of impact of a contextual override based on historical observations relating to energy pricing structure, applied schedule for appliances, user behaviour (i.e. vetoes), and environmental conditions. The invention does not rely on a change in energy use for it to start energy savings, it will anticipate a possible increase in energy use and adjust an appliance accordingly so that possible increase is prevented;
The present invention takes real-time energy use and energy pricing information into account as well as assessing past user behaviour to determine a probabilistic optimisation model for controlling thermostat setpoints, which is most likely to minimise customer dissatisfaction and thus maximise energy savings;
The present invention utilises aggregated energy consumption, anticipation of peak demand charges, and customer feedback to verify the occurrence of a change in operational status for climate control systems, such that a change in operational status of a climate control system will minimise customer dissatisfaction and maximise energy savings for the user.

In contrast to certain prior art disclosures, in which control is either reactive in nature or without any information on how such control was created, embodiments of the present invention focus on dynamic control as a function of a context like human in the loop, past and present user behavior, or system parameters like energy use or pricing.

In contrast to the prior art, where feedback control overrides user input during demand limiting events, embodiments of the present invention take user override into consideration (human in the loop) and dynamically adjust the control of the system to make sure a balance approach on energy reduction and user comfort is achieved.

In contrast to the prior, which may only relate to methods for adjusting a HVAC system's setpoint temperature based on a forecasted ambient temperature, embodiments of the present invention take on more parameters and variables to determine an ideal setpoint temperature. In addition, embodiments of the present invention are not limited to adjusting setpoint temperature of an HVAC system but also schedule when an HVAC should be running or turned off, the minimum and maximum setpoint temperature that can be configured to a giving HVAC system, and dynamically control all these parameters in real time to achieve the most efficient energy consumption achievable.

Advantageously, embodiments of the present invention may improve the participation rate of incentive-based demand response programs in which an energy focused company will give participants incentives in the form of hardware rebates, bill discounts, among other things. The participant rate may be greatly affected as the inconvenience far outweighs the perceived savings to the participant. Using a method that takes into account the weather, past and present participant behavior, as well as other components of a participant's site (does it have solar and/or battery, etc) in other words context then the participation rate is expected to be higher as the present invention takes into account a participants convenience when trying to achieve savings.

Advantageously, embodiments of the present invention may minimize the barrier of adoption for renewable energy particularly in a residential setting. One of the barriers for user adoption of renewable energy is due to a lengthy payback period because of the cost of installing solar PV and onsite battery storage. Embodiments of the present invention may address this barrier by allowing lower cost and smaller capacity battery storage units to be used thus reducing the payback period for using renewable energy. In addition, embodiments of the present invention may also incorporate a dynamic energy reduction algorithm that takes user behavior and environmental factors into consideration ensuring the effectiveness of the energy reduction initiatives. This will also further reduce the payback period for consumers.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 illustrates an example relating to the concept of ‘context’ according to the present invention in accordance with a preferred embodiment;

FIG. 1A shows typical conditions for current drawn by an air conditioning system in accordance with prior art;

FIG. 2 is a flow chart illustrating high-level operation of the method and system of the present invention in accordance with a preferred embodiment;

FIG. 3 is a flow chart illustrating operation of the method and system of the present invention in fully automatic mode in accordance with a preferred embodiment;

FIG. 4 is a flow chart illustrating operation of the present invention as applied to a HVAC system in accordance with a preferred embodiment;

FIG. 5 is a flow chart illustrating operation of the method and system of the present invention in accordance with a preferred embodiment when options for control are presented to a customer;

FIG. 6A and FIG. 6B depict schematically and graphically two further situations in which the system of the present invention would provide energy use benefits in accordance with preferred embodiments;

FIG. 7 is a plot of ambient temperature of a building over a 24-hour period, which illustrates the drawback of residual heat accumulated in a building overnight and which is addressed by embodiments of the present invention.

### DETAILED DESCRIPTION

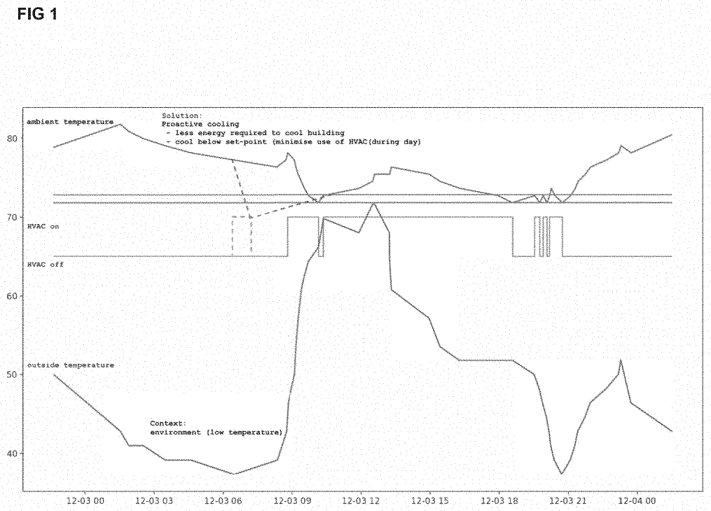

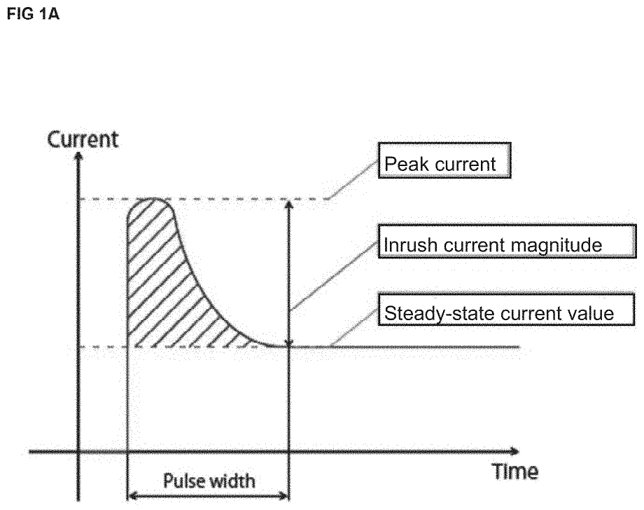

The inventor has recognised that heating, ventilation and air conditioning (HVAC) may form a large portion of the overall electricity consumption of a customer. Air conditioning systems draw a high inrush current before settling at the steady-state current. These conditions are illustrated in FIG. 1A. Thermostats have three states, HVAC on (compressor on), dead band and HVAC off. The tighter the dead band the tighter the control of the ambient temperature. Further, HVAC systems are not aware of the electricity pricing structure and don't take it into account when controlling the ambient temperature. Also, HVAC systems are not aware of aggregate demand, e.g. multiple compressors starting simultaneously and causing a demand peak due to their inrush current. Other appliances could also cause a peak. As a result, the cost of electricity from HVAC use is higher than necessary due to this unawareness of pricing structure.

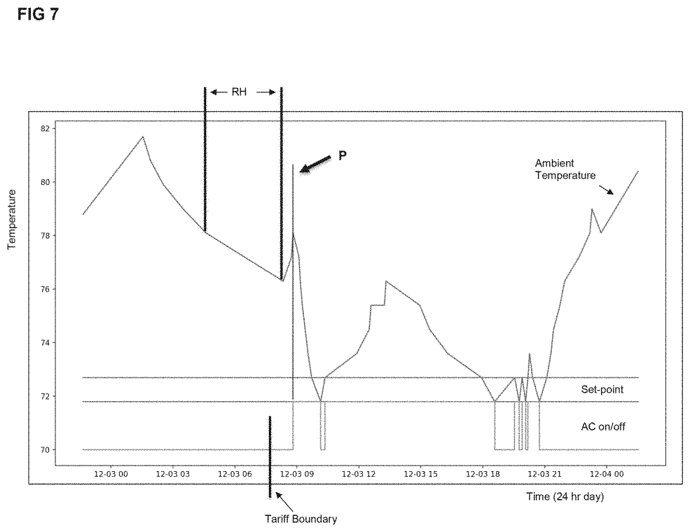

With reference to FIG. 7, which reproduces the graphical representations of FIG. 1 without the plot of ambient temperature, it has been recognised by the inventor that HVAC systems are not optimally operated as they lack context of weather and building parameters. For example, consider a building where the HVAC is switched off in the evening, for example, at or about 9 pm. Pursuant to the HVAC being switched off at this time, the ambient temperature of the building will continue to rise overnight. After midnight, the heat will slowly dissipate. However, there will be heat that remains in the building overnight which is indicated as residual heat (‘RH’) in FIG. 7. The problem, indicated from point ‘P’ of FIG. 7, is that the ‘RH’ must be removed in addition to the incoming heat of the day by running the HVAC at expensive mid-peak electricity rates. An alternative would be to run the HVAC for short periods of time overnight at cheap off-peak electricity rates. In this respect, the building might be cheaply pre-cooled during night as the outside temperature at this time is significantly below the outside temperature in the morning when the actual HVAC schedule starts. In this respect, a solution may be that the HVAC is run for a short period of time, for example, 20 minutes from 5 am. Alternatively, only the fan, without compressor, may be run for a short period, say 40 minutes from 5 am. This is illustrated by the dotted lines of FIG. 1 corresponding to this time of day and further described below in an example of identifying a context in accordance with an embodiment.

Where used herein, the term ‘context’ is intended to refer to a situation that provides an opportunity to save energy cost, with minimal compromising of comfort.

For example, context may include dimming lights when natural light is available, which saves on costs but does not compromise comfort. In contrast, delaying an HVAC which results in increased ambient temperature would save cost but compromise comfort.

A context can lead to (i) proactive steps or (ii) reactive steps. Proactive steps would include pre-cooling a house at low demand time in anticipation of a heatwave or pre-heating a pool at low demand time in anticipation of a heatwave. Reactive steps would include avoiding drawing energy at times of peak demand.

### Example 1

The following example will be described with reference to FIG. 1 which illustrates how a context might be exploited based on real data. In California, nights are often cold and days are warm. An air-conditioner operating as a cooling appliance works more effectively if the outside temperature is low as it will take advantage of the cooler outside air when it is activated and circulates the inside air while it is reducing the ambient temperature to reach a given cooling setpoint. The operating schedule of the air-conditioner might start at 8 am in the morning, a time where the sun is already strong and the outside temperature high. In such a situation context could include anticipation of a peak demand (for customers that pay demand charges), variable energy pricing structure throughout the day or sudden change in environmental conditions, such as a drop in temperature. By activating the air-conditioner for a short period of time (depicted as dashed HVAC ON lines) while the outside temperature is low, less energy will be required to cool the building by the time the air-conditioning is scheduled to start (i.e. 8 am).

In accordance with preferred embodiments, the present invention includes two key steps in response to a context that override the effect that would otherwise occur and lead to a lower efficiency than that available if the method of the present invention is used. The two steps comprise:

(1) identifying opportunities to save energy and/or cost; and

(2) taking appropriate control action to exploit the identified opportunity.

As described above, a context is an opportunity for savings, typically savings in terms of energy, or cost, or both. The cost of energy depends on the time of the day (and other factors such as peak demand) and a reduction in cost might be the result of shifting energy consumption without actually consuming less energy. Saving energy might be the result of reducing waste by means of intelligent control.

For example, when a peak demand is anticipated, a laundry machine may be switched-off or the set-point of a HVAC may be adjusted to lower consumption.

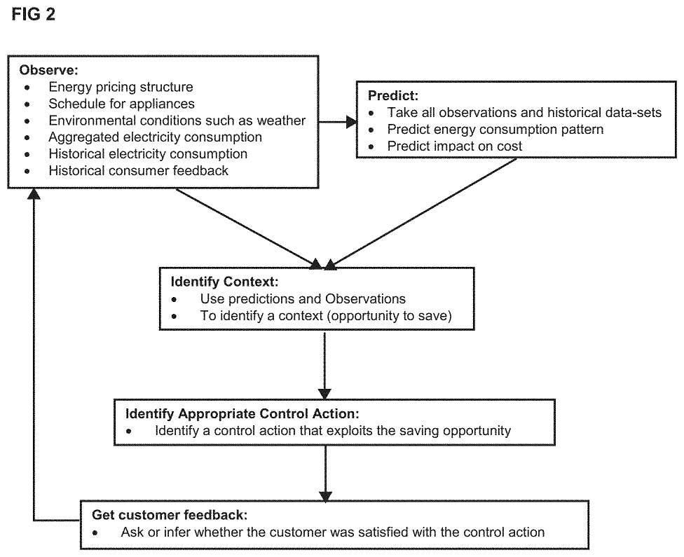

FIG. 2 contains a high-level description of how the system of the present invention works in accordance with a preferred embodiment. A listed set of parameters is monitored, as in the ‘observe’ box of FIG. 2, and used to make predictions, such as predicting demand peaks or sudden environmental changes. A context is identified based on observations, such as for a schedule of an appliance eg a HVAC, or pricing structures and predictions. After identifying a context, an appropriate control action is taken. The control action is either fully automatic or alternatively, may comprise presenting a number of control actions to the customer so that they can decide which one to execute and which to ignore. The customer decisions may be recorded and used for future decision making, hence the process may be somewhat iterative in character in this respect.

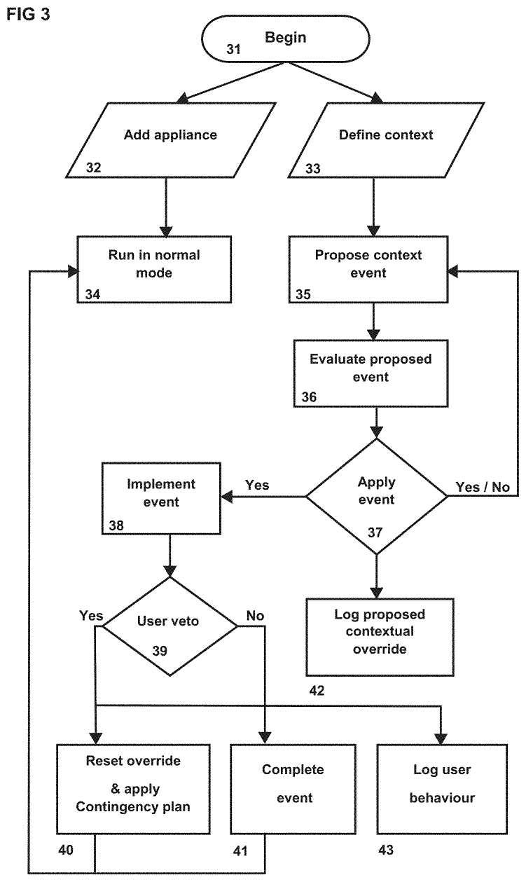

FIG. 3 is a flow chart that illustrates how a fully automatic response to override appliances with the effects of a context would typically work. Each appliance to be included in the scheme is added (32) and a set of contexts are defined (33). For example, if a laundry washing machine or dryer is added to the scheme, respective context and action pairs might be:
(i) Demand peak anticipated—Stop execution if running or prevent starting the machine;
(ii) Lower price is anticipated—Propose to delay operation of the machine.

Appliances run in normal mode (34). The system of this embodiment continuously observes all relevant parameters, such as aggregate demand, and weather and proposes contexts (35). Each proposed context and respective action is assessed (36). The assessment function evaluates the proposed action and whether it will result in energy or cost efficiencies either alone or in combination with other control actions. One or more control actions that will lead to efficiencies will be automatically implemented (37) in one or more appliances as appropriate. A proposed context is assessed through the following: (1) was a similar proposed context applied previously and if so was it vetoed by the customer or run unchanged; (2) if a similar proposed context was previously vetoed was it cancelled or changed; (3) should a proposed context reflect the changes applied by the user when it previously vetoed a similar context; (4) will a modified proposed context result in energy savings. A respective action is assessed through the following: (1) did the customer veto the respective action; (2) if so was the veto a cancel of the respective action or a change of one of the parameters of the respective action; (3) record the energy savings of an unchanged action; (4) record the energy savings of a vetoed action (but only changed); (5) record the energy usage of a vetoed action (cancelled action).

The control action, if it is to be applied, is implemented (37) until (or unless) the user vetos the decision of the system. A veto right may be important to avoid discomfort and potentially dangerous situations. If no veto is issued the proposed action is completed (41) otherwise a contingency plan is executed (40) before returning to normal mode.

The proposed control actions (42) and user actions (43) are recorded. The data recorded is used to influence the assessment function. Recorded data influences the assessment function by: (1) recorded control actions that resulted in considerable energy savings have a higher probability of being utilised in the future; (2) recorded control actions that have an associated user action (i.e. veto or change in control action parameter) will be adjusted based on the user action in future use. By recording (i) proposed contextual events, (ii) the decision of the assessment function and (iii) user vetoes after implementing the action, the system will build a database that can provide control actions that better meet user preferences and thus minimise the number of future vetos by the user. A probabilistic optimisation model can be used to decide which context control action pair is most likely to minimise customer dissatisfaction whilst maximising savings.

### Example 2

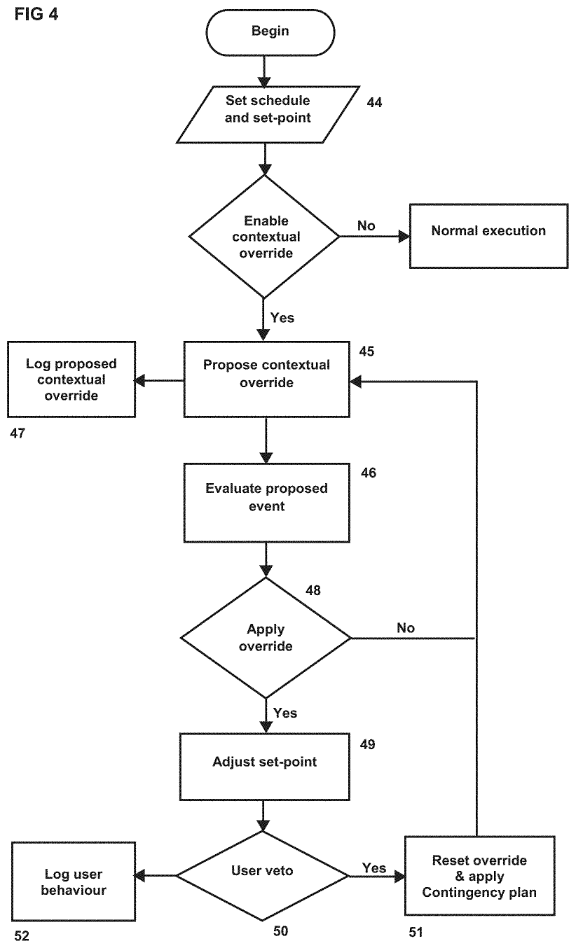

FIG. 4 is a flowchart illustrating responses to override a context (‘contextual override’) according to embodiments of the present invention for a HVAC system. First (44) a schedule and set-point are set for the HVAC system. If the contextual override is disabled, the HVAC and system runs in normal execution mode.

If the contextual override is enabled, the system starts working in normal mode, yet is ready to accept contextual overrides. While the HVAC system is running, another system is working in the background and continuously proposes contextual overrides, such as adjusting the set-point to pre-cool a building or switching the HVAC off for a while.

The proposed contextual override is evaluated, for example, it may be evaluated (46) against a previous similar event and whether the corresponding control action was vetoed or implemented by the consumer (47). If the evaluation permits the override, it is executed (48) for example, by adjusting the set-point (49). If the user issues a veto (50), for example, by manually adjusting the set-point using the thermostat during the event the contextual override is reverted (51) and a contingency plan may be executed. Thereafter, the system waits for upcoming contextual override proposals. User behaviour may be logged (52) and used for future reference.

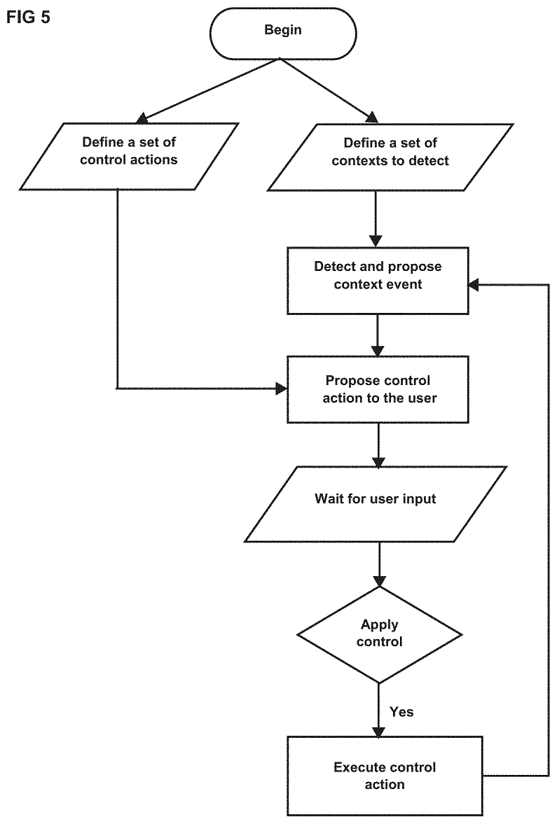

FIG. 5 is a flowchart illustrating one embodiment of the present invention that includes the user in the implementation of the present invention. Similarly, to the embodiments previously described, a set of contexts are defined to which system will react and subsequently a set of control actions are defined, which are typically user specific. After initialising the system, it continuously searches for contexts.

In this embodiment, if a context is detected an electronic alert is sent to the user, such as to their phone or email account. The user is presented with one or more control actions and asked to decide which to execute. One or more control actions are executed on the basis of the user choice.

The main goals behind putting a user in the loop are (i) to minimise customer discontent, and (ii) to help the customer understand their system.

Several advantages arise from proposing a set of control actions to the user and letting them decide which to implement. One advantage is that the user feels that they have control of the system and responsibility over the outcome. Furthermore, the user develops an understanding of the system, the context and learns how to exercise better control of the system through their decisions.

This may be preferable to a fully automated system which does not have access to information such as the day to day changing preferences of a user. However, the system may log user preferences for future reference and use them as input to presentation of control actions next time a similar context occurs.

For example, in a further embodiment of the present invention, after the contexts are detected automatically, the user may receive an electronic alert. For example, an alert could read “We anticipate a demand peak this afternoon and this will trigger extra demand charges. We suggest avoiding use of your laundry machine between 3 and 4 pm. Would you like to implement this suggestion?”

After the demand peak event the user could receive a message stating “Thanks for implementing the proposed actions, the expected savings are 15 cents. Do you think the suggested control actions were worth it? Would you like to implement similar control actions in future?”

The system may log the user control action choices and responses to queries relating to the effectiveness of the outcomes derived from those control action choices.

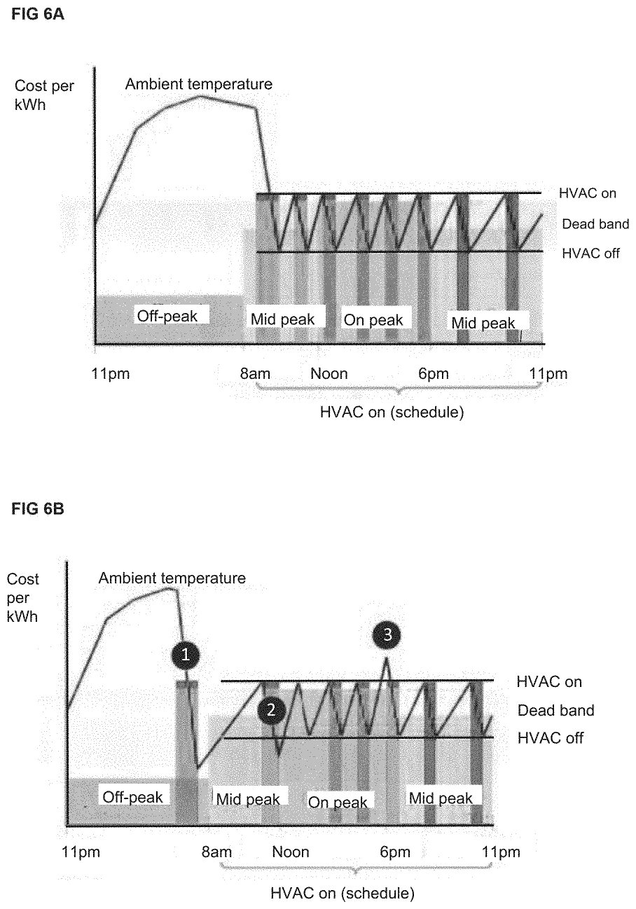

FIG. 6A and FIG. 6B illustrate further embodiments that are examples of use of the method and system of the present invention with reference to heating-ventilation and air conditioning (HVAC) systems.

HVACs can be a significant part of the overall electricity consumption of an energy user. Air conditioning systems draw a high inrush current before settling at the steady-state current. The associated thermostats have three states; (i) HVAC on (compressor on), (ii) dead band and (iii) HVAC off. The narrower the dead band the tighter the control of the temperature.

HVAC systems of the prior art operate independently and without regard to an electricity pricing structure. Furthermore, HVAC systems operate without regard to aggregate demand, that is, the total demand when multiple HVAC compressors (or other appliances) start simultaneously and cause a demand peak due to their inrush current. HVACs are particularly problematic because they are relatively expensive to run. HVAC systems also operate without information in the context of temperature, weather and building parameters.

FIG. 6A is a schematic drawing of typical operation of a prior art HVAC cooling schedule in a commercial office building in which workers are typically present between 8 am and 8 pm. The ambient temperature in the building rises during the off-peak period between 11 pm and 8 am. The HVAC is scheduled to cool the inside of the building between 8 am and 11 pm, spanning the mid-peak and peak periods. The schedule and thermostats cause the HVAC cooling to automatically turn on and off within the dead band.

FIG. 6B is a schematic drawing of operation of an HVAC according to the method of a preferred embodiment of the present invention. The system of the present invention causes the HVAC to turn on and pre-cool the building (1) during the off-peak period prior to 8 am. This is in anticipation of future HVAC demand and increased mid-peak pricing later in the morning and takes advantage of the outside temperature being significantly less than the temperature inside the building. Utilities (i.e. Energy retailers) publish off-peak, mid-peak, on-peak periods for a given day, month, season, or in some cases in real time. This information is then used along with the knowledge of outside temperature, building schedule for the HVAC, and past user behaviour to apply pre-cooling during off-peak periods to reduce HVAC runtime. Pre-cooling event are applied when (base on the schedule) an HVAC demand is anticipated to occur close to the boundary of an off-peak period and mid-peak/on-peak period.

The system of the present invention may also propose switching off the HVAC during the late evening to reduce the amount of time that mid-peak prices are paid and to take advantage of the falling temperatures outside the building.

The present system may also provide users with proposed control actions so that they can veto any that may not be appropriate.

It is noted that the above examples relate to cooling a building, but similar examples can be envisaged with respect to heating a building using a HVAC or cycling between heating and cooling when using a reverse cycle system.

The abovementioned control by the system of these embodiments can be applied to appliances other than HVACs. For example, the system and method of the present invention may be relevant to energy consuming appliances such as lights or lighting systems. For indoor environments, such as office spaces, supermarkets and so forth, well documented recommended light levels (Illuminance) are available. Embodiments of the invention can be applicable to lighting systems by utilising the same input that is utilised for HVAC control namely: peak periods, outside weather, schedule, and user behaviour. In addition, preferred embodiments of the invention will also utilise other input that affects the control of lighting systems like indoor light sensors, occupancy sensors. Using this information lighting systems can be switched off when there is enough outside light detected during peak periods and there is no occupant in the building; Lighting systems dimmed when there is enough outside light detected and people are detected in the building.

The light level in rooms with windows or other openings that allow natural light to enter is the sum of natural and artificial light. If more natural light is available, such as on a cloudless summer day when bright sunshine comes into the room, less artificial light is required. Light control without regard to the natural light level may waste energy because the sum of natural and artificial light exceeds the recommended comfort level.

Other appliances that would benefit from the system and method of the present invention include consumer appliances such as fridges, washing machines, TVs, radios, and so forth and larger household appliances such a pool heaters and sewer pumps. Some of these are not necessarily time dependent—for example a pool can be pre-heated or the heating can be delayed.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, any means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

The following sections I-VII provide a guide to interpreting the present specification.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

It should be noted that where the terms “server”, “secure server” or similar terms are used herein, a communication device is described that may be used in a communication system, unless the context of the description otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™ Pentium II™ Xeon™ Celeron™, Pentium Pro™, Efficeon™ Athlon™ AMD™ and the like), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; Linux and XML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context of the description clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

We claim:

1. A method for managing supply of energy to a plurality of energy consuming devices connected to a power distribution system of an energy supply system, the method comprising the steps of:
(1) monitoring one or more parameters affecting energy usage,
(2) acquiring a first set of values based on the parameters,
(3) calculating a set of predicted future values based on the first set of values,
(4) identifying a context related to the first set of values, and
(5) presenting control actions to increase efficiency of energy supply in response to the context.

2. A method as claimed in claim 1 wherein step (1) comprises monitoring a plurality of parameters affecting energy usage.

3. A method as claimed in claim 1 wherein at step (5), the control actions are presented in an automatic control mode of the operation of one or more energy consuming devices.

4. A method as claimed in claim 1 wherein the control actions are presented to a user for selection to implement or veto one or more of the control options presented.

5. A method as claimed in claim 4 wherein the control options selected by the user, either to implement or veto, are logged to in future be one of the energy usage parameters monitored in step (1) of claim 1.

6. A method as claimed in claim 4 wherein the control actions are presented to a user via a mobile device.

7. A method as claimed in claim 6 wherein the mobile device comprises a mobile telephone.

8. A method as claimed in claim 1 wherein the parameters monitored are chosen from one or a combination of:
an energy pricing structure;
a schedule for an energy consuming appliance;
weather conditions;
aggregate electricity consumption;
historical electricity consumption; and,
historical user feedback.

9. A method as claimed in claim 1 wherein the first set of values acquired from the monitored parameters include values of one or a combination of:
energy demand peak times;
energy prices;
temperature;
humidity.

10. A method as claimed in claim 1 wherein the first set of values are used to predict future values comprising predicted energy consumption patterns opposite predicted cost impacts.

11. A system for managing supply of energy to a plurality of energy consuming devices said system including a computer usable medium having computer readable program code and computer readable system code embodied on said medium for managing supply of energy usage across the plurality of energy consuming devices, said computer program product including computer readable code within said computer usable medium for:
(1) monitoring one or more, preferably a plurality of parameters relating to energy usage,
(2) acquiring a first set of values based on the parameters,
(3) calculating a set of predicted future values based on the first set of values,
(4) identifying a context based on the first set of values, and
(5) presenting control actions to increase efficiency of energy supply in response to the context.

12. An apparatus adapted to control energy usage across a plurality of energy consuming devices wherein each, said apparatus comprising;
processor means adapted to operate in accordance with a predetermined instruction set, and
said apparatus, in conjunction with said instruction set, being adapted to perform the method of claim 1.

13. (canceled)

14. (canceled)
